(19) United States
(12) Patent Application Publication
(10) Pub. No.: US 2026/0121365 A1
(43) Pub. Date: Apr. 30, 2026

(54) CHARGER

(71) Applicant: Chicony Power Technology Co., Ltd., New Taipei City (TW)

(72) Inventor: Min-Yao Shih, New Taipei City (TW)

(73) Assignee: Chicony Power Technology Co., Ltd., New Taipei City (TW)

(21) Appl. No.: 19/003,436

(22) Filed: Dec. 27, 2024

(30) Foreign Application Priority Data
Oct. 1, 2024 (TW) 113137644

(51) Int. Cl. H01R 31/06; H01R 13/24

(52) U.S. Cl. CPC H01R 31/065; H01R 13/2442; H01R 13/2471

(57) ABSTRACT

A charger is provided, including a body and a plug. The body includes a plug receiving portion and an insertion portion. A metal contact piece is arranged on the plug receiving portion. The plug is detachably assembled on the body, and the plug includes a first surface, a second surface, a third surface, a live wire terminal, a neutral wire terminal, a ground terminal, and a coupling portion. The third surface is a surface respectively adjacent to the first surface and the second surface. A contact end of the ground terminal protrudes from the second surface, and the coupling portion is located on the third surface. The coupling portion is correspondingly assembled to the insertion portion, and the contact end of the ground terminal is arranged corresponding to the metal contact piece and continuously abuts against the metal contact piece under an acting force.

### CROSS-REFERENCE TO RELATED APPLICATION

This non-provisional application claims priority under 35 U.S.C. § 119(a) to Patent Application No. 113137644 filed in Taiwan, R.O.C. on Oct. 1, 2024, the entire contents of which are hereby incorporated by reference.

### BACKGROUND

### Technical Field

The present invention relates to a charger, and in particular, to a charger with a detachable plug.

### Related Art

Generally, a socket with a common standard C8 specification lacks a ground terminal for grounding. Consequently, electric leakage is prone to occur, and electrical characteristics are further affected. In addition, a socket with an existing specification cannot convert a structure of a terminal according to usage conditions, and cannot adaptively change the structure when grounding is required.

### SUMMARY

In view of this, according to an embodiment, a charger is provided, including a body and a plug. The body includes a plug receiving portion and an insertion portion. The plug receiving portion is provided with a metal contact piece. The plug is detachably assembled on the body, and the plug includes a first surface, a second surface, a third surface, a live wire terminal, a neutral wire terminal, a ground terminal, and a coupling portion. The first surface and the second surface are opposite surfaces, and the third surface is a surface respectively adjacent to the first surface and the second surface. A contact end of the ground terminal protrudes from the second surface, and the coupling portion is located on the third surface. The coupling portion is correspondingly assembled to the insertion portion, and the contact end of the ground terminal is arranged corresponding to the metal contact piece and continuously abuts against the metal contact piece under an acting force.

In some embodiments, the contact end of the ground terminal is of a pogo pin structure.

In some embodiments, the contact end of the ground terminal includes an elastic piece portion and a contact portion, and the contact portion is connected to the elastic piece portion and is movable relative to the plug through the elastic piece portion.

In some embodiments, a sliding portion is arranged on each of two opposite sides of the metal contact piece, a sliding groove portion is arranged on the plug corresponding to the sliding portion, and the plug is slidably arranged on the sliding portion through the sliding groove portion.

In some embodiments, the contact end of the ground terminal abuts against the metal contact piece to form a conductive path.

In some embodiments, the body further includes a circuit board, and the circuit board is electrically connected to the metal contact piece.

In some embodiments, the body further includes a metal protection plate, and the metal contact piece is electrically connected to the circuit board through the metal protection plate.

In some embodiments, the metal protection plate includes a first pin and a second pin, the first pin abuts against the metal contact piece, and the second pin abuts against the circuit board.

In some embodiments, one end of each of the live wire terminal and the neutral wire terminal protrudes from the first surface, an opposite other end of each of the live wire terminal and the neutral wire terminal extends toward the third surface to be accommodated in the coupling portion, and a connection end of the ground terminal relative to the contact end protrudes from the first surface.

In some embodiments, the coupling portion is a convex portion, the convex portion includes two insertion holes, the insertion portion is a concave portion, the concave portion includes two metal guide pins, the convex portion is accommodated in the concave portion, and the two metal guide pins are accommodated in the two insertion holes.

In summary, a charger is provided according to an embodiment. When a detachable plug having the ground terminal is assembled on the body, the ground terminal is in conduction with the metal contact piece to achieve a grounding effect. In this way, a user can easily replace different plugs on the body according to usage conditions, to implement a structure of the charger applicable to socket structures of different specifications.

### BRIEF DESCRIPTION OF THE DRAWINGS

FIG. 1 is a three-dimensional diagram of a charger according to a first embodiment;

FIG. 2 is an exploded view of a charger according to a first embodiment;

FIG. 3 is an exploded view of a charger from another angle according to a first embodiment;

FIG. 4 is a schematic diagram of a contact end according to a first embodiment; and

FIG. 5 is a three-dimensional diagram of a plug according to a second embodiment.

### DETAILED DESCRIPTION

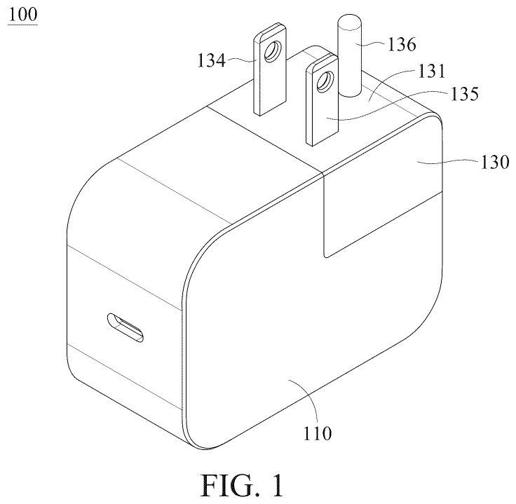

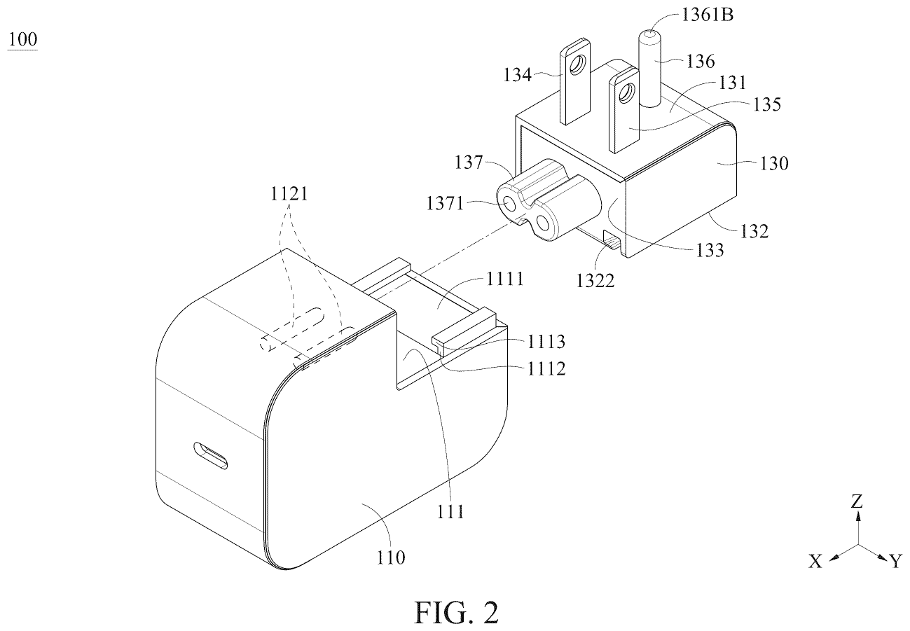

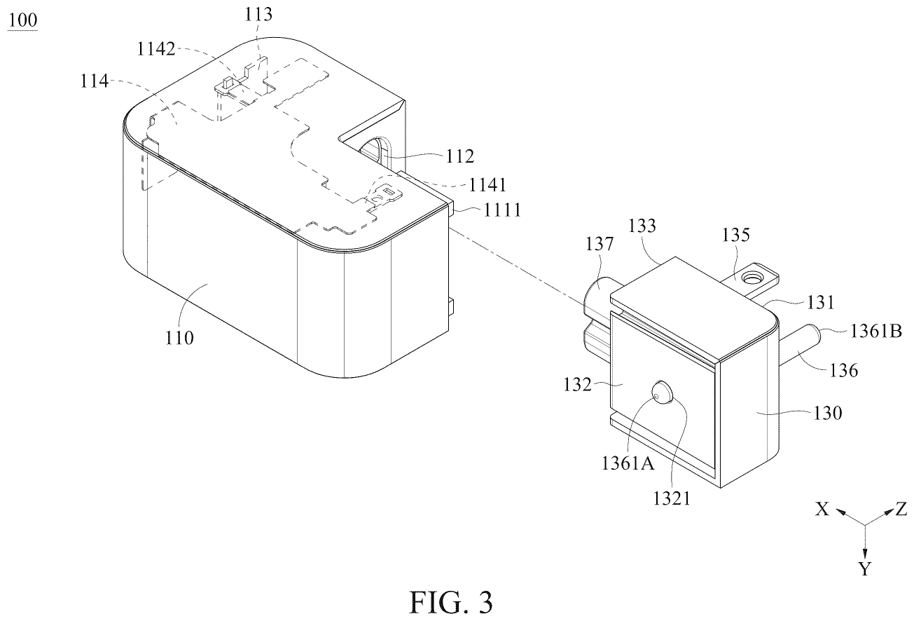

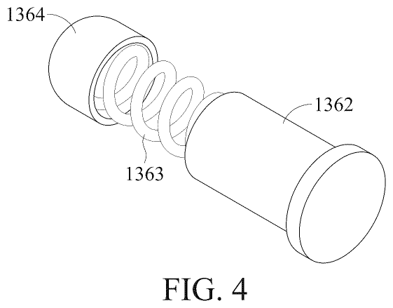

Refer to FIG. 1 to FIG. 4. FIG. 1 is a three-dimensional diagram of a charger according to a first embodiment. FIG. 2 is an exploded view of a charger according to a first embodiment. FIG. 3 is an exploded view of a charger from another angle according to a first embodiment. FIG. 4 is a schematic diagram of a contact end according to a first embodiment. A charger 100 includes a body 110 and a plug 130. In this embodiment, the charger 100 is a charger with a C8 specification.

The body 110 includes a plug receiving portion 111 and an insertion portion 112. A metal contact piece 1111 is arranged on the plug receiving portion 111. In this embodiment, the plug receiving portion 111 and the insertion portion 112 are respectively located on perpendicularly adjacent surfaces, the insertion portion 112 is configured to assemble the plug 130, and the metal contact piece 1111 on the plug receiving portion 111 is configured to be in conduction with a ground terminal 136 of the plug 130. Structures of the insertion portion 112 and the metal contact piece 1111 are described in detail below.

The plug 130 is detachably assembled on the body 110. The plug 130 includes a first surface 131, a second surface 132, a third surface 133, a live wire terminal 134, a neutral wire terminal 135, the ground terminal 136, and a coupling portion 137. The first surface 131 and the second surface 132 are opposite surfaces, and the third surface 133 is a surface respectively adjacent to the first surface 131 and the second surface 132. A contact end 1361A of the ground terminal 136 protrudes from the second surface 132, and the coupling portion 137 is located on the third surface 133. The coupling portion 137 is correspondingly assembled to the insertion portion 112, and the contact end 1361A of the ground terminal 136 is arranged corresponding to the metal contact piece 1111, and continuously abuts against the metal contact piece 1111 under an acting force. In this embodiment, one end of each of the live wire terminal 134 and the neutral wire terminal 135 protrudes from the first surface 131, and an opposite other end of each of the live wire terminal 134 and the neutral wire terminal 135 extends toward the third surface 133 to be accommodated in the coupling portion 137. The ground terminal 136 protrudes from the first surface 131 relative to a connection end 1361B of the contact end 1361A. In this embodiment, as shown in FIG. 2, the plug 130 is inserted along a first axis X parallel to a surface of the plug receiving portion 111, and the coupling portion 137 is inserted into the insertion portion 112. In addition, during insertion of the plug 130 into the body 110, the contact end 1361A continuously abuts against the metal contact piece 1111, and cause ground terminal 136 to become in conduction with the metal contact piece 1111.

Specifically, the plug 130 having the ground terminal 136 is assembled on the body 110, and the contact end 1361A of the ground terminal 136 is in conduction with the metal contact piece 1111 on the body 110, so as to provide the charger 100 with a grounding effect. In addition, because the plug 130 may be easily detached from the body 110, a user can easily replace different plugs on the body 110 according to usage conditions. Therefore, a structure of the charger 100 applicable to sockets of different specifications is implemented.

In this embodiment, as shown in FIG. 2 to FIG. 4, the contact end 1361A of the ground terminal 136 is of a pogo pin structure. The pogo pin structure includes a pin tube 1362, a spring 1363, and a pin shaft 1364. The pin shaft 1364 is connected to the pin tube 1362 by using the spring 1363 and is movable relative to the pin tube 1362. The second surface 132 of the plug 130 is provided with a slot 1321, the pin tube 1362 is provided in the slot 1321, and the pin shaft 1364 continuously abuts outward under an elastic force of the spring 1363 and protrudes from the slot 1321. During insertion of the plug 130 into the body 110, the pin shaft 1364 abuts against the metal contact piece 1111, and compresses the spring 1363. In this way, an effect that the pin shaft 1364 continuously abuts against the metal contact piece 1111 to maintain mutual conduction can be maintained. In addition, the contact end 1361A of the ground terminal 136 abuts against the metal contact piece 1111 to form a conductive path.

In this embodiment, as shown in FIG. 2 and FIG. 3, a sliding portion 1112 is arranged on each of two opposite sides of the metal contact piece 1111, a sliding groove portion 1322 is arranged on the plug 130 corresponding to the sliding portion 1112, and the plug 130 is slidably arranged on the sliding portion 1112 through the sliding groove portion 1322. The sliding portion 1112 extends in a direction of the first axis X. The second surface 132 of the plug 130 is provided with the sliding groove portion 1322 in the direction of the first axis X. In this way, the plug 130 may be inserted into the body 110 along the first axis X. In addition, in this embodiment, the metal contact piece 1111 further includes a hook portion 1113, and the hook portion 1113 protrudes from an end of the sliding portion 1112 in a direction of a second axis Y orthogonal to the first axis X. In this way, when the plug 130 is assembled on the body 110, movement of the plug 130 in a direction of a third axis Z orthogonal to the first axis X and the second axis Y can be further limited.

In this embodiment, as shown in FIG. 3, the body 110 further includes a circuit board 113, and the circuit board 113 is electrically connected to the metal contact piece 1111. In this embodiment, a metal protection plate 114 is arranged in the body 110, and the metal contact piece 1111 is electrically connected to the circuit board 113 through the metal protection plate 114. In this way, in addition to protecting an internal structure, the metal protection plate 114 can also achieve an electrical connection effect. In this embodiment, the metal protection plate 114 includes a first pin 1141 and a second pin 1142, the first pin 1141 abuts against the metal contact piece 1111, and the second pin 1142 abuts against the circuit board 113.

In this embodiment, as shown in FIG. 2 and FIG. 3, the coupling portion 137 is a convex portion, and the convex portion includes two insertion holes 1371. The insertion portion 112 is a concave portion, and the concave portion includes two metal guide pins 1121. The convex portion is accommodated in the concave portion, and the two metal guide pins 1121 are inserted into the two insertion holes 1371. In this embodiment, the plug 130 is assembled on the body 110 by assembling the coupling portion 137 as the convex portion to the insertion portion 112 as the concave portion, and the live wire terminal 134 and the neutral wire terminal 135 of the plug 130 are electrically connected to the circuit board 113 of the body 110 through the two metal guide pins 1121. In another implementation, the coupling portion 137 may alternatively be a concave portion, and the insertion portion 112 may alternatively be a convex portion.

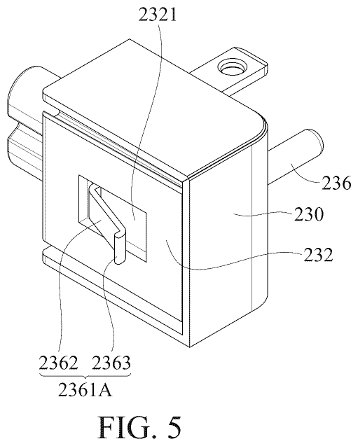

In a first embodiment, it is illustrated that the contact end 1361A is of a pogo pin structure, but this application is not limited thereto. Refer to FIG. 5. FIG. 5 is a three-dimensional diagram of a plug according to a second embodiment. In the second embodiment, the contact end 2361A of the ground terminal 236 includes an elastic piece portion 2362 and a contact portion 2363, and the contact portion 2363 is connected to the elastic piece portion 2362 and is movable relative to the plug 230 through the elastic piece portion 2362. In this embodiment, the second surface 232 of the plug 230 is provided with an opening groove 2321. An end of the elastic piece portion 2362 is arranged in the opening groove 2321. The contact portion 2363 continuously abuts outward under an elastic force of the elastic piece portion 2362 and protrudes from the opening groove 2321. During insertion of the plug 230 into the body 110 shown in FIG. 1 and FIG. 2, the contact portion 2363 abuts against the metal contact piece 1111, and compresses the elastic piece portion 2362. In this way, an effect that the contact portion 2363 continuously abuts against the metal contact piece 1111 to keep the contact end 2361A and the metal contact piece 1111 in conduction with each other can be maintained.

In summary, a charger 100 is provided according to an embodiment. The plug 130 and the plug 230 that have the ground terminal 136 and the ground terminal 236 are assembled on the body 110, and the contact end 1361A and the contact end 2361A of the ground terminal 136 and the ground terminal 236 and the metal contact piece 1111 on the body 110 are connected to each other, to provide a grounding effect of the charger 100. In addition, because the plug 130 and the plug 230 can be easily detached from the body 110, the user can easily replace different plug 130 and different plug 230 on the body 110 according to usage conditions, to implement a structure of the charger 100 applicable to sockets of different specifications.

What is claimed is:

1. A charger, comprising:
a body, comprising a plug receiving portion and an insertion portion, wherein a metal contact piece is arranged on the plug receiving portion; and
a plug, detachably assembled on the body, wherein the plug comprises a first surface, a second surface, a third surface, a live wire terminal, a neutral wire terminal, a ground terminal, and a coupling portion, the first surface and the second surface are opposite surfaces, the third surface is a surface respectively adjacent to the first surface and the second surface, a contact end of the ground terminal protrudes from the second surface, and the coupling portion is located on the third surface, wherein
the coupling portion is correspondingly assembled to the insertion portion, and the contact end of the ground terminal is arranged corresponding to the metal contact piece and continuously abuts against the metal contact piece under an acting force.

2. The charger according to claim 1, wherein the contact end of the ground terminal is of a pogo pin structure.

3. The charger according to claim 1, wherein the contact end of the ground terminal comprises an elastic piece portion and a contact portion, and the contact portion is connected to the elastic piece portion and is movable relative to the plug through the elastic piece portion.

4. The charger according to claim 1, wherein a sliding portion is arranged on each of two opposite sides of the metal contact piece, a sliding groove portion is arranged on the plug corresponding to the sliding portion, and the plug is slidably arranged on the sliding portion through the sliding groove portion.

5. The charger according to claim 1, wherein the contact end of the ground terminal abuts against the metal contact piece to form a conductive path.

6. The charger according to claim 1, wherein the body further comprises a circuit board, and the circuit board is electrically connected to the metal contact piece.

7. The charger according to claim 6, wherein the body further comprises a metal protection plate, and the metal contact piece is electrically connected to the circuit board through the metal protection plate.

8. The charger according to claim 7, wherein the metal protection plate comprises a first pin and a second pin, the first pin abuts against the metal contact piece, and the second pin abuts against the circuit board.

9. The charger according to claim 1, wherein one end of each of the live wire terminal and the neutral wire terminal protrudes from the first surface, an opposite other end of each of the live wire terminal and the neutral wire terminal extends toward the third surface to be accommodated in the coupling portion, and a connection end of the ground terminal relative to the contact end protrudes from the first surface.

10. The charger according to claim 1, wherein the coupling portion is a convex portion, the convex portion comprises two insertion holes, the insertion portion is a concave portion, the concave portion comprises two metal guide pins, the convex portion is accommodated in the concave portion, and the two metal guide pins are accommodated in the two insertion holes.
